(19) United States
(12) Patent Application Publication
(10) Pub. No.: US 2011/0235526 A1
(43) Pub. Date: Sep. 29, 2011

(54) METHOD, SYSTEM, AND NETWORK ELEMENT DEVICE FOR CONFIGURING ALARM PERFORMANCE

(76) Inventor: Qiliang YI, Shenzhen (CN)

(21) Appl. No.: 13/030,826

(22) Filed: Feb. 18, 2011

Related U.S. Application Data
(63) Continuation of application No. PCT/CN2009/073313, filed on Aug. 18, 2009.

(30) Foreign Application Priority Data
Aug. 19, 2008 (CN) 200810141930.3

(51) Int. Cl. H04L 12/26

(52) U.S. Cl. 370/242

(57) ABSTRACT

A method, a system, and a network element device for configuring alarm performance are provided. The method for configuring the alarm performance includes the following steps. A network element on a Label Switched Path (LSP) acquires a signaling, where the signaling carries alarm performance configuration information of the LSP; and the network element configures an alarm performance attribute of the network element according to the alarm performance configuration information of the LSP carried in the signaling. Accordingly, a system and a network element device for configuring alarm performance are provided. Thus, automatic alarm performance configuration of the LSP can be implemented by transmitting the signaling along the network elements on the LSP and carrying the alarm performance configuration information in the signaling, thereby reducing a workload for a user to perform the alarm performance configuration.

### CROSS-REFERENCE TO RELATED APPLICATIONS

This application is a continuation of International Application No. PCT/CN2009/073313, filed on Aug. 18, 2009, which claims priority to Chinese Patent Application No. 200810141930.3, filed on Aug. 19, 2008, both of which are hereby incorporated by reference in their entireties.

### FIELD OF THE TECHNOLOGY

The present invention relates to the filed of communication technologies, and more particularly, to a method, a system, and a network element device for configuring alarm performance.

### BACKGROUND OF THE INVENTION

Alarm performance is an important function in the network operation and maintenance process, and plays an important role in monitoring and locating network failures, evaluating various services provided by the network, and improving network reliability. During maintaining a Label Switched Path (LSP) in the network, some interfaces are provided on a device for a user to flexibly configure an alarm performance attribute of the LSP in the network.

The alarm performance configuration of the LSP is performed after a network manager delivers a command, which is inefficient if many LSPs exist.

### SUMMARY OF THE INVENTION

In order to improve the efficiency of alarm performance configuration of an LSP, the present invention provides a method, a network element device, and a system for configuring alarm performance.

A method for configuring alarm performance is provided, which includes the following steps.

A network element on an LSP acquires a signaling, where the signaling carries alarm performance configuration information of the LSP.

The network element configures an alarm performance attribute of the network element according to the alarm performance configuration information of the LSP carried in the signaling.

A network element device is provided, which includes a first configuring unit.

The first configuring unit is adapted to receive a signaling from a previous network element on an LSP of the network element device, where the signaling carries alarm performance configuration information of the LSP of the network element device; and configure an alarm performance attribute of the network element device according to the alarm performance configuration information of the LSP carried in the signaling.

Preferably, the network element device further includes a first sending unit, adapted to transmit the signaling to a next network element of the network element device on the LSP.

A network element device is further provided, which includes a second configuring unit and a second sending unit.

The second configuring unit is adapted to acquire alarm performance configuration information of an LSP of the network element device, and initiate a signaling, where the signaling carries the alarm performance configuration information of the LSP; and configure an alarm performance attribute of the source network element device according to the alarm performance configuration information of the LSP carried in the signaling.

The second sending unit is adapted to transmit the signaling to a next network element of the network element device on the LSP.

A system for configuring alarm performance is further provided, which includes a source network element and a destination network element located on an LSP.

The source network element is adapted to acquire a signaling, where the signaling carries alarm performance configuration information of the LSP; configure an alarm performance attribute of the source network element according to the alarm performance configuration information of the LSP carried in the signaling; and transmit the signaling to a next network element of the source network element on the LSP.

The destination network element is adapted to receive a signaling from a previous network element of the destination network element on the LSP, where the signaling carries the alarm performance configuration information of the LSP; and configure an alarm performance attribute of the destination network element according to the alarm performance configuration information of the LSP carried in the signaling.

A method for configuring alarm performance is further provided, which includes the following steps.

A network element on a LSP acquires a signaling, where the signaling carries alarm performance configuration information of the LSP and preset network element configuration information, and the preset network element configuration information is for indicating whether alarm performance configuration is performed on only one or more preset network elements on the LSP.

The network element determines whether the alarm performance configuration is required to be performed on the network element according to the preset network element configuration information.

If the alarm performance configuration is required to be performed on the network element, an alarm performance attribute of the network element is configured according to the alarm performance configuration information of the LSP.

A network element device is provided, which includes a signaling acquiring unit, a determining unit, and a configuring unit.

The signaling acquiring unit is adapted to acquire a signaling, where the signaling carries alarm performance configuration information of a LSP of the network element device and preset network element configuration information, and the preset network element configuration information is for indicating whether alarm performance configuration is performed on only one or more preset network elements on the LSP.

The determining unit is adapted to determine whether the alarm performance configuration is required to be performed on the network element device according to the preset network element configuration information.

The configuring unit is adapted to configure an alarm performance attribute of the network element according to the alarm performance configuration information of the LSP, when the determining unit determines that alarm performance configuration is required to be performed on the network element device.

According to embodiments of the present invention, automatic alarm performance configuration of the LSP can be implemented by transmitting signaling along network elements on the LSP and carrying the alarm performance configuration information in the signaling, thus reducing a workload for a user to perform the alarm performance configuration.

### BRIEF DESCRIPTION OF THE DRAWINGS

FIG. 1 is a flow chart of a method for configuring alarm performance according to an embodiment of the present invention;

FIG. 2 is a schematic view of an LSP which carries alarm performance configuration information by using a Path message in a Resource Reservation Protocol Traffic Engineering (RSVP-TE) signaling according to an embodiment of the present invention;

and

FIG. 3 is a schematic diagram of an LSP on which an alarm performance configuration is required to be performed after rerouting occurs according to an embodiment of the present invention.

### DETAILED DESCRIPTION OF THE EMBODIMENTS

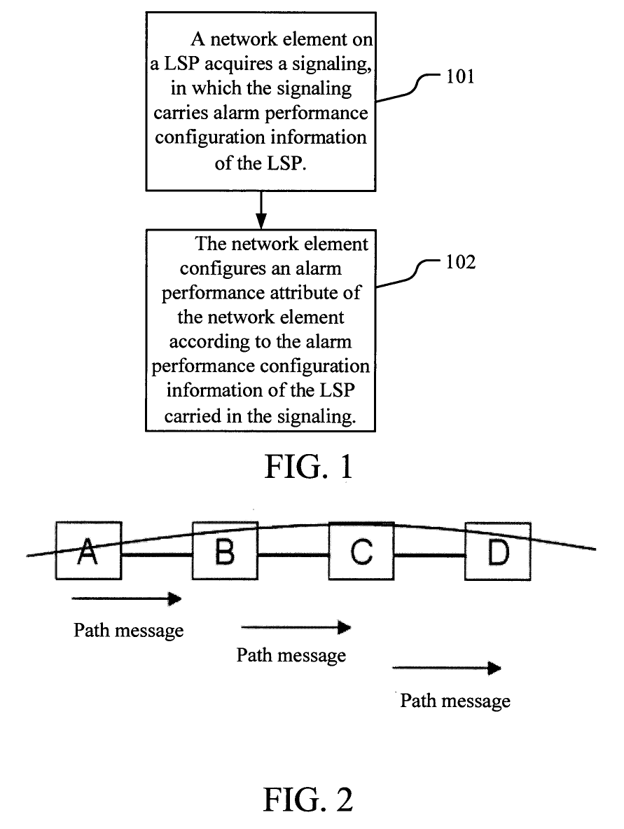

As shown in FIG. 1, a method for configuring alarm performance according to an embodiment of the present invention includes the following steps.

In step 101, a network element on an LSP acquires a signaling, where the signaling carries alarm performance configuration information of the LSP.

The alarm performance configuration information of the LSP may include one or more types of the following information: global alarm indication information, for indicating whether to monitor all alarms on the LSP and indicating whether to report all the alarms on the LSP; global performance indication information, for indicating whether to monitor all performances on the LSP and indicating whether to report all the performances on the LSP; preset alarm indication information, for indicating whether to monitor preset alarms on the LSP and indicating whether to report the preset alarms on the LSP; and preset performance indication information, for indicating whether to monitor preset performances on the LSP and indicating whether to report the preset performances on the LSP.

When the alarm performance configuration information of the LSP includes several kinds of information, the alarm performance configuration information of the LSP may further include one or more types of the following information: information for indicating an alarm suppression relation on the LSP, and information for indicating an alarm level.

Generally, when the alarm performance configuration information of the LSP includes both the global alarm indication information and the preset alarm indication information, alarm performance configuration is performed by default according to contents of the preset alarm indication information. That is, a priority of the preset alarm indication information is higher than that of the global alarm indication information. It is also possible to set in advance to perform the alarm performance configuration according to contents of the global alarm indication information by default. That is, to set that the priority of the global alarm indication information is higher than that of the preset alarm indication information. Similarly, the alarm performance configuration can be generally performed by default according to contents of the preset performance indication information, when the alarm performance configuration information of the LSP includes both the global performance indication information and the preset performance indication information. It is also possible to set in advance to perform the alarm performance configuration according to the global performance indication information by default.

When an LSP has been established in the network and no service is accessed, a user may not want to see the alarm performance on the LSP. Here, an alarm performance attribute of a network element on the LSP can be configured to not monitor and not report all the alarm performances on the LSP by setting the global alarm indication information in the alarm performance configuration information of the LSP to indicate not to monitor and not to report all alarms on the LSP and setting the global performance indication information to indicate not to monitor and not to report all performances on the LSP.

When the LSP is in a test state, the user may want to see only some concerned alarms or performances. Here, the user can configure the alarm performance attribute of the network element on the LSP to only monitor and report the concerned alarms and the concerned performances of the user and not to monitor and report other alarms and performances, by setting the preset alarm indication information and the preset performance indication information in the alarm performance configuration information of the LSP to monitor and report the concerned alarms and the concerned performances of the user.

When one failure occurs in the network, several alarms may be generated. For example, if one optical fiber is interrupted in a Synchronous Digital Hierarchy (SDH) network, many alarms may occur, such as Loss of Signal (LOS), Multiplex Section AIS (MS-AIS) and Tributary Unit AIS (TU-AIS). If all the alarms are reported to a user, it will be more difficult for the user to locate the failure. Therefore, the user can configure an alarm suppression relation on the LSP by setting information for indicating the alarm suppression relation on the LSP in the alarm performance configuration information of the LSP. For example, the LOS alarm is set to suppress the MS-AIS alarm, the MS-AIS alarm is set to suppress the TU-AIS alarm, when the LOS alarm, the MS-AIS alarm, and the TU-AIS alarm occur on a network element at the same time, only the LOS alarm will be reported; and when the MS-AIS alarm and the TU-AIS alarm occur on a network element at the same time, only the MS-AIS alarm will be reported, thus reducing the number of alarms reported to the user.

In step 102, the network element on the LSP configures an alarm performance attribute of the network element according to the alarm performance configuration information of the LSP carried in the signaling.

In an embodiment of the present invention, the alarm performance configuration information of the LSP includes the global alarm indication information.

When the global alarm indication information indicates to monitor but not to report all the alarms on the LSP, accordingly, the configuring the alarm performance attribute of the network element according to the alarm performance configuration information of the LSP carried in the signaling includes configuring the alarm performance attribute of the network element to monitor but not to report all the alarms on the LSP.

When the global alarm indication information indicates to monitor and report all the alarms on the LSP, accordingly, the configuring the alarm performance attribute of the network element according to the alarm performance configuration information of the LSP carried in the signaling includes configuring the alarm performance attribute of the network element to monitor and report all the alarms on the LSP.

When the global alarm indication information indicates not to monitor and not to report all the alarms on the LSP, accordingly, the configuring the alarm performance attribute of the network element according to the alarm performance configuration information of the LSP carried in the signaling includes configuring the alarm performance attribute of the network element not to monitor and not to report all the alarms on the LSP.

The alarm performance configuration information of the LSP may further include the global performance indication information.

When the global alarm indication information indicates to monitor but not to report all the performances on the LSP, accordingly, the configuring the alarm performance attribute of the network element according to the alarm performance configuration information of the LSP carried in the signaling includes configuring the alarm performance attribute of the network element to monitor but not to report all the performances on the LSP.

When the global alarm indication information indicates to monitor and report all the performances on the LSP, accordingly, the configuring the alarm performance attribute of the network element according to the alarm performance configuration information of the LSP carried in the signaling includes configuring the alarm performance attribute of the network element to monitor and report all the performances on the LSP.

When the global alarm indication information indicates not to monitor and not to report all the performances on the LSP, accordingly, the configuring the alarm performance attribute of the network element according to the alarm performance configuration information of the LSP carried in the signaling includes configuring the alarm performance attribute of the network element not to monitor and not to report all the performances on the LSP.

The alarm performance configuration information of the LSP may only include the global alarm indication information, or only include the global performance indication information, or include both the global alarm indication information and the global performance indication information.

In another embodiment of the present invention, the alarm performance configuration information of the LSP may include the preset alarm indication information.

When the preset alarm indication information indicates to monitor but not to report one or more preset alarms, accordingly, the configuring the alarm performance attribute of the network element according to the alarm performance configuration information of the LSP carried in the signaling includes configuring the alarm performance attribute of the network element to monitor but not to report the one or more preset alarms.

When the preset alarm indication information indicates to monitor and to report one or more preset alarms, accordingly, the configuring the alarm performance attribute of the network element according to the alarm performance configuration information of the LSP carried in the signaling includes configuring the alarm performance attribute of the network element to monitor and to report the one or more preset alarms.

When the preset alarm indication information indicates not to monitor and not to report one or more preset alarms, accordingly, the configuring the alarm performance attribute of the network element according to the alarm performance configuration information of the LSP carried in the signaling includes configuring the alarm performance attribute of the network element not to monitor and not to report the one or more preset alarms.

The alarm performance configuration information of the LSP may further include the preset performance indication information.

When the preset alarm indication information indicates to monitor but not to report one or more preset performances, accordingly, the configuring the alarm performance attribute of the network element according to the alarm performance configuration information of the LSP carried in the signaling includes configuring the alarm performance attribute of the network element to monitor but not to report the one or more preset performances.

When the preset alarm indication information indicates to monitor and to report one or more preset performances, accordingly, the configuring the alarm performance attribute of the network element according to the alarm performance configuration information of the LSP carried in the signaling includes configuring the alarm performance attribute of the network element to monitor and to report the one or more preset performances.

When the preset alarm indication information indicates not to monitor and not to report one or more preset performances, accordingly, the configuring the alarm performance attribute of the network element according to the alarm performance configuration information of the LSP carried in the signaling includes configuring the alarm performance attribute of the network element not to monitor and not to report the one or more preset performances.

The alarm performance configuration information of the LSP may only include the preset alarm indication information, or only include the preset performance indication information, or include both the preset alarm indication information and the preset performance indication information.

In the embodiments of the present invention, the alarm performance configuration information of the LSP includes at least one of the following information: the global alarm indication information, the global performance indication information, the preset alarm indication information, and the preset performance indication information. The specific implementations of them are similar, and will not be repeated herein.

In the present invention, automatic alarm performance configuration of the LSP can be implemented by transmitting signaling along network elements on the LSP and carrying the alarm performance configuration information in the signaling, thus reducing the workload for a user to perform the alarm performance configuration.

In an embodiment of the present invention in the following, an RSVP-TE signaling is taken as an example, but it is not limited to the protocol in actual applications. The protocol signaling, such as a Constraint-based Routed Label Distribution Protocol (CR-LDP) and a Private Network-Node Interface (PNNI), may also employ the solutions of the present invention.

FIG. 2 shows an LSP which carries alarm performance configuration information by using a Path message in an RSVP-TE signaling. The LSP passes through four network elements being A, B, C, and D. At a particular moment, a user tests the LSP. The alarm performance configuration information of the LSP includes global performance indication information, preset alarm indication information, and information for indicating the alarm suppression relation on the LSP. Specific settings of the information are as follows: The global performance indication information indicates not to monitor and not to report all the performances on the LSP, the preset alarm indication information indicates not to monitor and not to report a TU-AIS alarm and a TU-LOP alarm, and the information for indicating the alarm suppression relation on the LSP is set to be that a LOS alarm suppresses an MS-AIS alarm. The alarm performance configuration information required by the user is carried through the Path message in the RSVP-TE signaling. Each network element through which the LSP passes implements the configuration of the alarm performance attribute of the network element according to the alarm performance configuration information carried in the Path message after receiving the Path message.

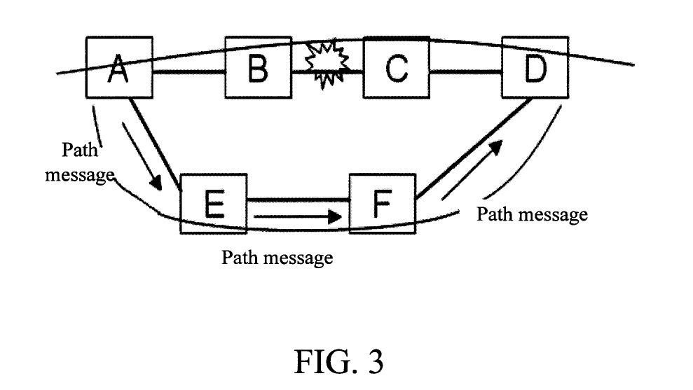

FIG. 3 shows an LSP on which alarm performance configuration is required to be performed after rerouting occurs. The alarm performance configuration information of the LSP includes preset performance indication information, and the preset performance indication information indicates not to monitor and not to report Continuity Check (CC) and Jitter. The LSP passes through four network elements being A-B-C-D. At a particular moment, a B-C link is interrupted, the network element A initiates rerouting to the LSP, and the rerouted LSP passes through four network elements being A-E-F-D. The alarm performance information of the LSP configured by a user before rerouting is not to monitor and not to report CC and Jitter. Therefore, when the node A establishes the rerouted LSP through signaling, the alarm performance configuration information is carried in the signaling, so that the rerouted LSP has the same alarm performance configuration as the LSP before rerouting, thus greatly reducing the workload for the user to perform the manual alarm performance information configuration.

Based on the implementation of the above method, in an embodiment, the present invention provides a network element, which includes a first configuring unit.

The first configuring unit is adapted to receive a signaling, where the signaling carries alarm performance configuration information of an LSP of the network element device; and configure the alarm performance attribute of the network element device according to the alarm performance configuration information of the LSP carried in the signaling.

The network element device may further include a first sending unit, adapted to transmit the signaling to a next network element of the network element device on the LSP.

In another embodiment, the present invention provides a network element device, which includes a second configuring unit and a second sending unit.

The second configuring unit is adapted to acquire alarm performance configuration information of an LSP of the network element device, and initiate a signaling, where the signaling carries the alarm performance configuration information of the LSP; and configure the alarm performance attribute of the network element device according to the alarm performance configuration information of the LSP carried in the signaling.

The second sending unit is adapted to transmit the signaling to a next network element of the network element device on the LSP.

In an embodiment, the present invention further provides a network element device. The network element device may be an intermediate network element, and includes a first configuring unit and a first sending unit.

The first configuring unit is adapted to receive a signaling from a previous network element on a LSP of the network element device, and configure the alarm performance attribute of the network element device according to alarm performance configuration information of the LSP carried in the signaling.

The first sending unit is adapted to transmit the signaling to a next network element of the network element device on the LSP.

In an embodiment, the present invention further provides a network element device. The network element device may be a source network element, and includes a second configuring unit and a second sending unit.

The second configuring unit is adapted to acquire alarm performance configuration information of an LSP of the network element device, and initiate a signaling, where the signaling carries the alarm performance configuration information of the LSP; and configure an alarm performance attribute of the source network element device according to the alarm performance configuration information of the LSP carried in the signaling.

The second sending unit is adapted to transmit the signaling to a next network element of the network element device on the LSP.

In an embodiment, the present invention further provides a network element device. The network element device may be a destination network element, and includes a third configuring unit.

The third configuring unit is adapted to receive a signaling from a previous network element on an LSP of the network element device, where the signaling carries alarm performance configuration information of the LSP; and configure an alarm performance attribute of the network element device according to the alarm performance configuration information of the LSP carried in the signaling.

In an embodiment, the present invention further provides a system for configuring alarm performance, which includes a source network element and a destination network element located on an LSP.

The source network element is adapted to acquire alarm performance configuration information of the LSP, and initiate a signaling, where the signaling carries the alarm performance configuration information of the LSP; configure an alarm performance attribute of the source network element according to the alarm performance configuration information of the LSP carried in the signaling; and transmit the signaling to a next network element of the source network element on the LSP.

The destination network element is adapted to acquire a signaling from a previous network element of the destination network element on the LSP, where the LSP carries the signaling carries the alarm performance configuration information of the LSP; and configure an alarm performance attribute of the network element according to the alarm performance configuration information of the LSP carried in the signaling.

An intermediate network element may further exist between the source network element and the destination network element on the LSP. The intermediate network element is adapted to receive a signaling from a previous network element of the intermediate network on the LSP, and configure an alarm performance attribute of the intermediate network element according to alarm performance configuration information of the LSP carried in the signaling; and transmit the signaling to a next network element of the intermediate network element on the LSP.

In the present invention, automatic alarm performance configuration of the LSP can be implemented by transmitting signaling along network elements on the LSP and carrying the alarm performance configuration information in the signaling, thus reducing the workload for a user to perform the alarm performance configuration.

In another embodiment, the present invention provides a method for configuring alarm performance. The difference between the method and the method for configuring alarm performance according to the foregoing embodiment is that, in addition to the alarm performance configuration information of the LSP, preset network element configuration information is carried in the signaling acquired by the network element on the LSP, where the preset network element configuration information is for indicating whether alarm performance configuration is performed on only one or more preset network elements on the LSP. The method includes the following steps.

A network element on a LSP acquires a signaling, where the signaling carries alarm performance configuration information of the LSP and preset network element configuration information, where the preset network element configuration information is for indicating whether the alarm performance configuration is performed on only one or more preset network elements on the LSP.

The network element determines whether the alarm performance configuration is required to be performed on the network element according to the preset network element configuration information.

If the alarm performance configuration is required to be performed on the network element, an alarm performance attribute of the network element is configured according to the alarm performance configuration information of the LSP.

On the one hand, in the method for configuring alarm performance, when the preset network element configuration information indicates that alarm performance configuration is performed on one or more preset network elements on the LSP, the network element determining whether alarm performance configuration is required to be performed on the network element according to the preset network element configuration information includes the following steps.

The network element determines whether the network element belongs to the preset network elements.

If the network element belongs to the preset network elements, it is determined that the alarm performance configuration is required to be performed on the network element. If the network element does not belong to the preset network elements, it is determined that the alarm performance configuration is not required to be performed on the network element.

On the other hand, in the method for configuring alarm performance, when the preset network element configuration information indicates that the alarm performance configuration is not performed on one or more preset network elements on the LSP, the network element determining whether alarm performance configuration is required to be performed on the network element according to the preset network element configuration information includes the following steps.

The network element determines whether the network element belongs to the preset network elements.

If the network element does not belong to the preset network elements, it is determined that the alarm performance configuration is required to be performed on the network element. If the network element belongs to the preset network elements, it is determined that the alarm performance configuration is not required to be performed on the network element.

The alarm performance configuration information of the LSP may include one or more types of the following information: global alarm indication information, for indicating whether to monitor all alarms on the LSP and indicating whether to report all the alarms on the LSP; global performance indication information, for indicating whether to monitor all performances on the LSP and indicating whether to report all the performances on the LSP; preset alarm indication information, for indicating whether to monitor preset alarms on the LSP and indicating whether to report the preset alarms on the LSP; and preset performance indication information, for indicating whether to monitor preset performances on the LSP and indicating whether to report the preset performances on the LSP.

When it is determined that alarm performance configuration is required to be performed on the network element, a possible case is in the following.

The alarm performance configuration information of the LSP includes the global alarm indication information.

When the global alarm indication information indicates to monitor but not to report all the alarms on the LSP, accordingly, the configuring the alarm performance attribute of the network element according to the alarm performance configuration information of the LSP carried in the signaling includes configuring the alarm performance attribute of the network element to monitor but not to report all the alarms on the LSP.

When the global alarm indication information indicates to monitor and report all the alarms on the LSP, accordingly, the configuring the alarm performance attribute of the network element according to the alarm performance configuration information of the LSP carried in the signaling includes configuring the alarm performance attribute of the network element to monitor and report all the alarms on the LSP.

When the global alarm indication information indicates not to monitor and not to report all the alarms on the LSP, accordingly, the configuring the alarm performance attribute of the network element according to the alarm performance configuration information of the LSP carried in the signaling includes configuring the alarm performance attribute of the network element not to monitor and not to report all the alarms on the LSP.

In addition, the alarm performance configuration information of the LSP may further include the global performance indication information.

When the global alarm indication information indicates to monitor but not to report all the performances on the LSP, accordingly, the configuring the alarm performance attribute of the network element according to the alarm performance configuration information of the LSP carried in the signaling includes configuring the alarm performance attribute of the network element to monitor but not to report all the performances on the LSP.

When the global alarm indication information indicates to monitor and report all the performances on the LSP, accordingly, the configuring the alarm performance attribute of the network element according to the alarm performance configuration information of the LSP carried in the signaling includes configuring the alarm performance attribute of the network element to monitor and report all the performances on the LSP.

When the global alarm indication information indicates not to monitor and not to report all the performances on the LSP, accordingly, the configuring the alarm performance attribute of the network element according to the alarm performance configuration information of the LSP carried in the signaling includes configuring the alarm performance attribute of the network element not to monitor and not to report all the performances on the LSP.

The alarm performance configuration information of the LSP may only include the global alarm indication information, or only include the global performance indication information, or include both the global alarm indication information and the global performance indication information.

When it is determined that alarm performance configuration is required to be performed on the network element, another possible case is that the alarm performance configuration information of the LSP includes the preset alarm indication information.

When the preset alarm indication information indicates to monitor but not to report one or more preset alarms, accordingly, the configuring the alarm performance attribute of the network element according to the alarm performance configuration information of the LSP carried in the signaling includes configuring the alarm performance attribute of the network element to monitor but not to report the one or more preset alarms.

When the preset alarm indication information indicates to monitor and to report one or more preset alarms, accordingly, the configuring the alarm performance attribute of the network element according to the alarm performance configuration information of the LSP carried in the signaling includes configuring the alarm performance attribute of the network element to monitor and to report the one or more preset alarms.

When the preset alarm indication information indicates not to monitor and not to report one or more preset alarms, accordingly, the configuring the alarm performance attribute of the network element according to the alarm performance configuration information of the LSP carried in the signaling includes configuring the alarm performance attribute of the network element not to monitor and not to report the one or more preset alarms.

In addition, the alarm performance configuration information of the LSP may further include the preset performance indication information.

When the preset alarm indication information indicates to monitor but not to report one or more preset performances, accordingly, the configuring the alarm performance attribute of the network element according to the alarm performance configuration information of the LSP carried in the signaling includes configuring the alarm performance attribute of the network element to monitor but not to report the one or more preset performances.

When the preset alarm indication information indicates to monitor and to report one or more preset performances, accordingly, the configuring the alarm performance attribute of the network element according to the alarm performance configuration information of the LSP carried in the signaling includes configuring the alarm performance attribute of the network element to monitor and to report the one or more preset performances.

When the preset alarm indication information indicates not to monitor and not to report one or more preset performances, accordingly, the configuring the alarm performance attribute of the network element according to the alarm performance configuration information of the LSP carried in the signaling includes configuring the alarm performance attribute of the network element not to monitor and not to report the one or more preset performances.

The alarm performance configuration information of the LSP may only include the preset alarm indication information, or only include the preset performance indication information, or include both the preset alarm indication information and the preset performance indication information.

In an embodiment, the present invention further provides a network element device, which includes a signaling acquiring unit, a determining unit, and a configuring unit.

The signaling acquiring unit is adapted to acquire a signaling, where the signaling carries alarm performance configuration information of an LSP of the network element device and preset network element configuration information, and the preset network element configuration information is for indicating whether alarm performance configuration is performed on only one or more preset network elements on the LSP.

The determining unit is adapted to determine whether alarm performance configuration is required to be performed on the network element device according to the preset network element configuration information.

The configuring unit is adapted to configure an alarm performance attribute of the network element according to the alarm performance configuration information of the LSP, when the determining unit determines that the alarm performance configuration is required to be performed on the network element device.

In the present invention, the automatic alarm performance configuration of the LSP can be implemented by transmitting signaling along network elements on the LSP and carrying the alarm performance configuration information in the signaling, thus reducing the workload for a user to perform the alarm performance configuration.

Through the descriptions of the preceding embodiments, those skilled in the art may understand that the present invention may be implemented by using hardware only or by using software and a necessary universal hardware platform. Based on such understandings, all or part of the technical solution under the present invention that makes contributions to the prior art may be essentially embodied in the form of a software product. The software product may be stored in a storage medium, which can be a magnetic disk, a Compact Disk Read-Only Memory (CD-ROM), a Read-Only Memory (ROM) or a Random Access Memory (RAM). The software product includes a number of instructions that enable a computer device (personal computer, server, or network device) to execute the methods according to the embodiments of the present invention.

It should be noted that the above embodiments are merely provided for elaborating the technical solutions of the present invention, but not intended to limit the present invention. Although the present invention has been described in detail with reference to the foregoing embodiments, it is apparent that person having ordinary skill in the art can make various modifications or equivalent replacements to the technical solutions of the invention without departing from the spirit and scope of the invention. Any modification, equivalent replacement, or improvement made without departing from the spirit of the present invention should fall within the scope of the present invention.

What is claimed is:

1. A method for configuring alarm performance, comprising:
acquiring, by a network element on a Label Switched Path (LSP), a signaling, wherein the signaling carries alarm performance configuration information of the LSP; and
configuring, by the network element, an alarm performance attribute of the network element according to the alarm performance configuration information of the LSP carried in the signaling.

2. The method according to claim 1, wherein the alarm performance configuration information of the LSP comprises one or more kinds of the following information:
global alarm indication information, for indicating whether to monitor all alarms on the LSP and indicating whether to report all the alarms on the LSP; global performance indication information, for indicating whether to monitor performance on the LSP and indicating whether to report the performance on the LSP; preset alarm indication information, for indicating whether to monitor preset alarms on the LSP and indicating whether to report the preset alarms on the LSP; and preset performance indication information, for indicating whether to monitor preset performance on the LSP and indicating whether to report the preset performance on the LSP.

3. The method according to claim 2, wherein
the alarm performance configuration information of the LSP comprises the global alarm indication information;
when the global alarm indication information indicates to monitor but not to report all the alarms on the LSP,
accordingly, the configuring the alarm performance attribute of the network element according to the alarm performance configuration information of the LSP carried in the signaling comprises configuring the alarm performance attribute of the network element to monitor but not to report all the alarms on the LSP; or
when the global alarm indication information indicates to monitor and report all the alarms on the LSP,
accordingly, the configuring the alarm performance attribute of the network element according to the alarm performance configuration information of the LSP carried in the signaling comprises configuring the alarm performance attribute of the network element to monitor and report all the alarms on the LSP;
or
when the global alarm indication information indicates not to monitor and not to report all the alarms on the LSP,
accordingly, the configuring the alarm performance attribute of the network element according to the alarm performance configuration information of the LSP carried in the signaling comprises configuring the alarm performance attribute of the network element not to monitor and not to report all the alarms on the LSP.

4. The method according to claim 2, wherein
the alarm performance configuration information of the LSP comprises the global performance indication information;
when the global alarm indication information indicates to monitor but not to report the performance on the LSP,
accordingly, the configuring the alarm performance attribute of the network element according to the alarm performance configuration information of the LSP carried in the signaling comprises configuring the alarm performance attribute of the network element to monitor but not to report the performance on the LSP; or
when the global alarm indication information indicates to monitor and report the performance on the LSP,
accordingly, the configuring the alarm performance attribute of the network element according to the alarm performance configuration information of the LSP carried in the signaling comprises configuring the alarm performance attribute of the network element to monitor and report the performance on the LSP;
or
when the global alarm indication information indicates not to monitor and not to report the performance on the LSP,
accordingly, the configuring the alarm performance attribute of the network element according to the alarm performance configuration information of the LSP carried in the signaling comprises configuring the alarm performance attribute of the network element not to monitor and not to report the performance on the LSP.

5. The method according to claim 2, wherein
the alarm performance configuration information of the LSP comprises the preset alarm indication information;
when the preset alarm indication information indicates to monitor but not to report one or more preset alarms,
accordingly, the configuring the alarm performance attribute of the network element according to the alarm performance configuration information of the LSP carried in the signaling comprises configuring the alarm performance attribute of the network element to monitor but not to report the one or more preset alarms; or
when the preset alarm indication information indicates to monitor and to report the one or more preset alarms,
accordingly, the configuring the alarm performance attribute of the network element according to the alarm performance configuration information of the LSP carried in the signaling comprises configuring the alarm performance attribute of the network element to monitor and to report the one or more preset alarms; or
when the preset alarm indication information indicates not to monitor and not to report the one or more preset alarms,
accordingly, the configuring the alarm performance attribute of the network element according to the alarm performance configuration information of the LSP carried in the signaling comprises configuring the alarm performance attribute of the network element not to monitor and not to report the one or more preset alarms.

6. The method according to claim 2, wherein
the alarm performance configuration information of the LSP comprises the preset performance indication information;
when the preset alarm indication information indicates to monitor but not to report one or more preset performances,
accordingly, the configuring the alarm performance attribute of the network element according to the alarm performance configuration information of the LSP carried in the signaling comprises configuring the alarm performance attribute of the network element to monitor but not to report the one or more preset performances; or
when the preset alarm indication information indicates to monitor and to report the one or more preset performances,
accordingly, the configuring the alarm performance attribute of the network element according to the alarm performance configuration information of the LSP carried in the signaling comprises configuring the alarm performance attribute of the network element to monitor and to report the one or more preset performances; or
when the preset alarm indication information indicates not to monitor and not to report the one or more preset performances,
accordingly, the configuring the alarm performance attribute of the network element according to the alarm performance configuration information of the LSP carried in the signaling comprises configuring the alarm performance attribute of the network element not to monitor and not to report the one or more preset performances.

7. The method according to claim 2, wherein when the alarm performance configuration information of the LSP comprises several kinds of information, the alarm performance configuration information of the LSP further comprises one or more kinds of the following information:
information for indicating an alarm suppression relation on the LSP; and information for indicating an alarm level.

8. The method according to claim 1, wherein the signaling further carries preset network element configuration information, and the preset network element configuration information is for indicating whether alarm performance configuration is only performed on one or more preset network elements on the LSP, the configuring, by the network element, an alarm performance attribute of the network element according to the alarm performance configuration information of the LSP carried in the signaling comprises
determining, by the network element, whether the alarm performance configuration is required to be performed on the network element according to the preset network element configuration information; and
configuring an alarm performance attribute of the network element according to the alarm performance configuration information of the LSP, if the alarm performance configuration is required to be performed on the network element.

9. The method according to claim 8, wherein,
when the preset network element configuration information indicates that alarm performance configuration is performed on one or more preset network elements on the LSP,
the determining, by the network element, whether the alarm performance configuration is required to be performed on the network element according to the preset network element configuration information comprises:
determining, by the network element, whether the network element belongs to the preset network elements; and
determining that the alarm performance configuration is required to be performed on the network element, if the network element belongs to the preset network elements; or
when the preset network element configuration information indicates that the alarm performance configuration is not performed on the one or more preset network elements on the LSP,
the determining, by the network element, whether the alarm performance configuration is required to be performed on the network element according to the preset network element configuration information comprises
determining, by the network element, whether the network element belongs to the preset network elements; and
determining that alarm performance configuration is required to be performed on the network element, if the network element does not belong to the preset network elements.

10. A network element device, comprising:
a configuring unit, configured to receive a signaling from a previous network element device on a Label Switched Path (LSP) of the network element device, wherein the signaling carries alarm performance configuration information of the LSP of the network element device; and configure an alarm performance attribute of the network element device according to the alarm performance configuration information of the LSP carried in the signaling.

11. The network element device according to claim 10, further comprising:
a sending unit, configured to transmit the signaling to a next network element of the network element device on the LSP.

12. A network element device, comprising:
a configuring unit, configured to acquire alarm performance configuration information of a Label Switched Path (LSP) of the network element device, and initiate a signaling, wherein the signaling carries the alarm performance configuration information of the LSP, and configure an alarm performance attribute of the network element device according to the alarm performance configuration information of the LSP carried in the signaling; and
a sending unit, configured to transmit the signaling to a next network element of the network element device on the LSP.

13. A system for configuring alarm performance, comprising a source network element and a destination network element located on a Label Switched Path (LSP), wherein
the source network element is configured to acquire a signaling, wherein the signaling carries alarm performance configuration information of the LSP; configure an alarm performance attribute of the source network element according to the alarm performance configuration information of the LSP carried in the signaling; and transmit the signaling to a next network element of the source network element on the LSP; and
the destination network element is configured to receive a signaling from a previous network element of the destination network element on the LSP, wherein the signaling carries the alarm performance configuration information of the LSP; and configure an alarm performance attribute of the destination network element according to the alarm performance configuration information of the LSP carried in the signaling.

14. The system according to claim 13, wherein an intermediate network element further exists between the source network element and the destination network element on the LSP, and the intermediate network element is configured to:
receive a signaling from a previous network element of the intermediate network element on the LSP, and configure an alarm performance attribute of the intermediate network element according to alarm performance configuration information of the LSP carried in the signaling; and
transmit the signaling to a next network element of the intermediate network element on the LSP.
